(19) United States
(12) Patent Application Publication
(10) Pub. No.: US 2006/0179161 A1
(43) Pub. Date: Aug. 10, 2006

(54) Power management

(76) Inventors: Scott P. Dubal, Hillsboro, OR (US); Patrick Connor, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/054,914

(22) Filed: Feb. 9, 2005

(51) Int. Cl. G06F 15/16; G05B 19/18

(52) U.S. Cl. 709/250; 700/65

(57) ABSTRACT

In one embodiment, a method is provided that may include one or more operations. The one or more operations may comprise determining whether to supply to circuitry one or more actuating signals. The determining may be based, at least in part, upon one or more parameters issued from an authority that is remote from the circuitry. The one or more parameters may indicate, at least in part, one or more conditions under which the circuitry is to be powered up or deactivated. Many modifications, variations, and alternatives are possible without departing from this embodiment.

### FIELD

The subject application is related to the field of power management.

### BACKGROUND

In a typical corporate information technology and/or computing arrangement, a host owned by a corporation may be assigned to an employee of the corporation for use by the employee in carrying out the employee's work for the corporation. In this typical arrangement, the host executes an operating system and comprises network interface circuitry. An information technologist or system administrator in the corporation may issue commands to the operating system that initially may set conditions under which the operating system is to power up or deactivate certain host circuitry, such as, the network interface circuitry (or portions thereof) and/or other circuitry (e.g., the host's monitor). These initial conditions may be set in accordance, for example, an energy conservation policy mandated by the corporation to be used by its employees.

However, in this conventional arrangement, after the information technologist or system administrator has initially set these conditions, the employee may issue, via the operating system's user interface, additional instructions that may change the conditions under which the operating system is to power up and/or deactivate the host's circuitry. Indeed, in this conventional arrangement, it is possible for the employee to instruct the operating system not to power down the host's circuitry, unless specifically instructed to do so by the employee. Thus, in this conventional arrangement, the employee may be capable of circumventing and thwarting the corporation's energy conservation policy.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is diagram that illustrates a system embodiment.

FIG. 2 is a flowchart that illustrates operations that may be performed according to an embodiment.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

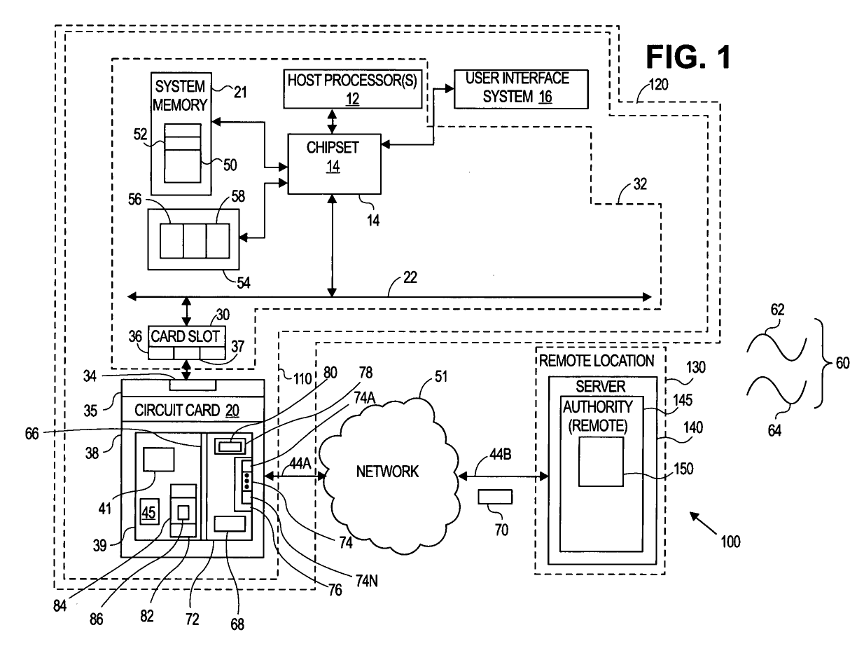

FIG. 1 illustrates a system embodiment 100. System 100 may comprise host 110. As used herein, a “host” means a system that comprises at least a processor and memory. As used herein, a “processor” means circuitry capable of executing one or more logical operations. Host 110 may be geographically located at a first location 120. Host 110 may comprise host processor 12 coupled to a chipset 14. Host processor 12 may comprise, for example, one or more Intel® Pentium® IV microprocessors commercially available from the Assignee of the subject application. Of course, alternatively, host processor 12 may comprise a plurality of microprocessors, another type of microprocessor, such as, for example, one or more microprocessors that may comprise a plurality of processor cores (not shown), and/or one or more microprocessors that are manufactured and/or commercially available from a source other than the Assignee of the subject application, without departing from this embodiment.

Host 110 also may comprise, for example, user interface system 16, bus system 22, circuit card slot 30, system memory 21, chipset 14, memory 54, and circuit card 20. Chipset 14 may comprise a bridge/hub system that may couple host processor 12, system memory 21, and user interface system 16 to each other. Chipset 14 may also include an input/output (I/O) bridge/hub system (not shown) that may couple the host bridge/bus system, and memory 54 to bus 22. Chipset 14 may comprise one or more integrated circuit chips, such as those selected from integrated circuit chipsets commercially available from the assignee of the subject application (e.g., graphics memory and I/O controller hub chipsets), although one or more other integrated circuit chips may also, or alternatively be used, without departing from this embodiment. User interface system 16 may comprise, e.g., a keyboard, pointing device, and display system that may permit a human user to input commands to, and monitor the operation of, system 100.

Memory 54 and memory 21 each may comprise one or more of the following types of machine-readable memories: semiconductor firmware memory, programmable memory, non-volatile memory, read only memory, electrically programmable memory, random access memory, flash memory, magnetic disk memory, and/or optical disk memory. For example, in this embodiment, memory 54 may comprise flash basic input/output system (BIOS) memory 56 and/or electrically erasable programmable memory (EEPROM) 58. Either additionally or alternatively, memory 54 and/or memory 21 may comprise other and/or later-developed types of computer-readable memory.

Bus 22 may comprise a bus that complies and/or is compatible with the Peripheral Component Interconnect (PCI) Express™ Base Specification Revision 1.0, published Jul. 22, 2002, available from the PCI Special Interest Group, Portland, Oreg., U.S.A., and/or later-developed version of said Specification (hereinafter collectively or singly referred to as a “PCI Express™ bus”). Alternatively, bus 22 may comprise other types and configurations of bus systems, without departing from this embodiment.

Circuit card slot 30 may comprise, for example, a PCI Express™ compatible or compliant expansion slot or interface 36. Interface 36 may comprise a bus connector 37 that may be electrically and mechanically mated with a mating bus connector 34 that may be comprised in a bus expansion slot or interface 35 in circuit card 20.

As used herein, “circuitry” may comprise, for example, singly or in any combination, analog circuitry, digital circuitry, logic circuitry, hardwired circuitry, programmable circuitry, state machine circuitry, and/or memory that may comprise machine-executable instructions that may be executed by programmable circuitry. Also as used herein, an “integrated circuit” means one or more semiconductor devices and/or one or more microelectronic devices, such as, for example, a semiconductor integrated circuit chip. In this embodiment, circuit card 20 may comprise operative circuitry 38. Operative circuitry 38 may comprise, for example, integrated circuit 39. Integrated circuit 39 may comprise microcontroller 41, memory 45, memory 82, and network interface circuitry 66. Microcontroller 41 may comprise one or more processors (not shown).

Memory 45 and memory 82 may comprise one or more of the following types of machine-readable memories: semiconductor firmware memory, programmable memory, non-volatile memory, read only memory, electrically programmable memory, random access memory, flash memory, magnetic disk memory, and/or optical disk memory. Either additionally or alternatively, memory 45 may comprise other and/or later-developed types of computer-readable memory.

Machine-executable instructions may be stored in memory 45. These instructions may be accessed and executed by operative circuitry 38, integrated circuit 39, and/or microcontroller 41. When so executed, these instructions may result in card 20, circuitry 38, integrated circuit 39, and/or microcontroller 41 performing the operations described herein as being performed by card 20, circuitry 38, integrated circuit 39, and/or microcontroller 41.

Slot 30 and card 20 may be constructed to permit card 20 to be inserted into slot 30. When card 20 is properly inserted into slot 30, connectors 34 and 37 may become electrically and mechanically coupled to each other. When connectors 34 and 37 are so coupled to each other, circuitry 38 may become electrically coupled to bus 22.

Alternatively, some or all of operative circuitry 38, integrated circuit 39, memory 45, memory 82, microcontroller 41, and/or circuitry 66 may not be comprised in card 20, but instead, may be comprised in one or more other structures, systems, and/or devices that may be, for example, comprised in motherboard 32, coupled to bus 22, and exchange data and/or commands with other components (such as, for example, chipset 14, network 51, server 140, remote authority 145, one or more agents 150, and/or other and/or additional components) in system 100. For example, in this alternative, some or all of operative circuitry 38, integrated circuit 39, memory 45, memory 82, microcontroller 41, and/or circuitry 66 may be comprised in one or more integrated circuits that may be comprised in and/or coupled to chipset 14, and may be coupled to server 140 via network 51. Also alternatively, some or all of operative circuitry 38, integrated circuit 39, memory 45, memory 82, microcontroller 41, and/or circuitry 66 may not be comprised in chipset 14, but may be comprised in motherboard 32 and coupled to server 140 via network 51. Also alternatively, some or all of memory 54, memory 56, and/or memory 58 may be comprised in card 20 (e.g., in circuit 39, memory 45, and/or memory 82). Many alternatives, modifications, and variations are possible. Processor 12, system memory 21, chipset 14, bus 22, circuit card slot 30, and memory 54 may be comprised in a single circuit board, such as, for example, system motherboard 32.

In this embodiment, network interface circuitry 66 may comprise media access control circuitry 72. Circuitry 72 may comprise, for example, memory interface circuitry 68, register set 78, and/or physical layer interface circuitry 76. Register set 78 may store one or more semaphores 80. Physical layer interface circuitry 76 may comprise port circuitry 74. Port circuitry 74 may comprise one or more ports 74A . . . 74N that may be coupled, via one or more network communication links 44A, to communication network 51. Additionally, system embodiment 100 may comprise server 140 that may be coupled, via one or more network communication links 44B, to communication network 51. Circuitry 66, circuitry 72, circuitry 76, circuitry 74, and/or one or more ports 74A . . . 74N may be capable of exchanging data and/or commands via one or more links 44A, network 51, and one or more links 44B in accordance with one or more of a variety of different communication protocols, e.g., Ethernet and/or TCP/IP communication protocols.

For example, in this embodiment, the Ethernet protocol may comply or be compatible with the protocol described in Institute of Electrical and Electronics Engineers, Inc. (IEEE) Std 802.3, 2000 Edition, published on Oct. 20, 2000. Also, for example, in this embodiment, the TCP/IP may comply or be compatible with the protocols described in Internet Engineering Task Force (IETF) Request For Comments (RFC) 791 and 793, published September 1981.

Server 140 may comprise a remote authority (e.g., a remote management authority) 145. Server 140 may be located at a location 130 that is geographically remote from the location 120 of host 110. Remote authority 145 may comprise one or more program processes including one or more agents 150 that may implement and/or carry out one or more management functions described herein. For example, in this embodiment, server 140 may comprise one or more processors (not shown) that may be capable of executing one or more machine-executable instructions that may result in the spawning and maintaining of agents 150 in server 140.

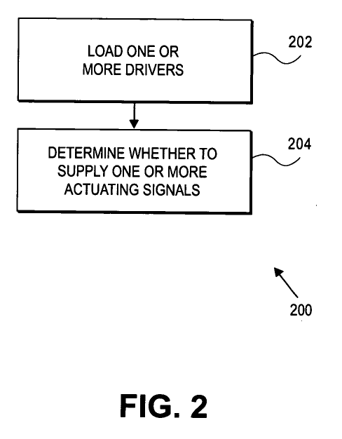

With reference now being made to FIG. 2, operations 200 that may be carried out in system 100 according to an embodiment will be described. After, for example, a reset of host 110, host processor 12 may boot an operating system by executing operating system instructions that may result, at least in part, in operating system 50 being loaded, at least in part, into memory 21. Operating system 50 may comprise one or more operating system processes 52. In this embodiment, one or more processes 52 may be or comprise, for example, one or more network communication driver processes.

However, after the reset of host 110, and prior to the booting of the operating system, executing of the operating system instructions, and/or loading of operating system 50 into system memory 21, microcontroller 41 may retrieve from memory 45 and/or from memory 54 via memory interface circuitry 68 and execute one or more program instructions. For example, in this embodiment, circuitry 68 may interface microcontroller 41 to memory 54, memory 56, and/or memory 58, and may permit microcontroller 41 to control operation of and retrieve data and/or instructions from memory 54, memory 56, and/or memory 58. The execution of these program instructions by microcontroller 41 may result in one or more drivers and/or driver program processes 84 being loaded in memory 82 and being executed by microcontroller 41, as illustrated by operation 202 in FIG. 2.

Thereafter, remote authority 145 and/or one or more processes 150 may generate, authorize, and issue to network interface circuitry 66 via network 51 one or more parameters 70. One or more parameters 70 may indicate, at least in part, one or more conditions under which at least certain circuitry in host 110 is to be powered up (e.g., activated) or powered down (e.g., deactivated).

For example, in this embodiment, one or more parameters 70 may indicate, at least in part, one or more conditions under which memory interface circuitry 68, memory 45, memory 54, memory 56, memory 58, some or all of network interface circuitry 66 (e.g., medium access control circuitry 72, physical layer circuitry 76, and/or one or more ports comprised in ports 74), and/or other circuitry in host 110 may be powered up or deactivated. Depending on, for example, the particular circuitry that is the subject of the one or more parameters 70, these one or more conditions may comprise an inactivity time of such circuitry, residence in memory of one or more program processes, and/or a failure condition.

More specifically, by way of illustrative example, in this embodiment, one or more parameters 70 may indicate, at least in part, that circuitry 68, memory 45, memory 54, memory 56, and/or memory 58 are to be powered down after one or more drivers and/or processes 84 have been loaded into and are resident in memory 82. Also by way of illustrative example, additionally or alternatively, one or more parameters 70 may indicate, at least in part, that, after a predetermined time period of inactivity of circuitry (e.g., circuitry 76 and/or one or more of the one or more ports 74A . . . 74N) comprised in network interface circuitry 66 has elapsed, the inactive circuitry (and/or other circuitry associated with the inactive circuitry) is to be deactivated.

After network interface circuitry 66 has received one or more parameters 70 from network 51, the execution by microcontroller 41 of one or more processes 84 may result in microcontroller 41 determining, based at least in part upon one or more parameters 70, whether to supply to the circuitry that is the subject of the one or more parameters 70 one or more actuating signals 60, as illustrated by operation 204 in FIG. 2. As used herein, an “actuating signal” means a signal that when supplied to circuitry results, at least in part, in the circuitry being capable of performing one or more operations. For example, in this embodiment, one or more actuating signals may comprise one or more voltage signals 62 and/or one or more current signals 64 generated and/or provided from one or more power supplies and/or sources (not shown) in host 110. When one or more signals 62 and/or 64 are supplied to the circuitry that is the subject of one or more parameters 70, the circuitry may be powered up; conversely, when one or more signals 62 and/or 64 are not supplied to the circuitry that is the subject of one or more parameters 70, the circuitry may be deactivated.

For example, in this embodiment, as part of operation 204, if one or more parameters 70 indicate, at least in part, that circuitry 68, memory 45, memory 54, memory 56, and/or memory 58 are to be powered down after one or more drivers and/or processes 84 have been loaded into and are resident in memory 82, microcontroller 41 may determine whether one or more processes 84 have been loaded into and are resident in memory 82. As part of this determination, microcontroller 41 may detect the presence of these one or more processes 84 in memory 82 and/or one or more processes 84 may signal microcontroller 41 when they are successfully loaded and resident in memory 82. After microcontroller 41 determines that one or more processes 84 have been loaded into and are resident in memory 82, microcontroller 41 may signal circuitry 68, memory 45, memory 54, memory 56, and/or memory 58. This may result in internal circuitry (not shown) in circuitry 68, memory 45, memory 54, memory 56, and/or memory 58 de-coupling circuitry 68, memory 45, memory 54, memory 56, and/or memory 58 from one or more actuating signals 60. This may result in circuitry 68, memory 45, memory 54, memory 56, and/or memory 58 entering a powered down state.

Also, in this embodiment, as part of operation 204, if one or more parameters 70 indicate, at least in part, that after a failure condition involving and/or predetermined time period of inactivity of circuitry that is the subject of one or more parameters 70, the circuitry is to be deactivated, microcontroller 41 may determine whether such a failure condition and/or predetermined time period of inactivity of such circuitry has occurred. For example, one or more parameters 70 may indicate, at least in part, that if one or more of the ports 74A . . . 74N fail and/or if one or more of the ports 74A . . . 74N have been inactive for a predetermined period of time, the one or more failed ports and/or one or more ports that have been inactive for the predetermined period time are to be deactivated. After, and in response, at least in part, to such parameters 70, microcontroller 41 may load into memory 82 and execute one or more watchdog timer processes 86. As a result of the execution of the one or more processes 86 by microcontroller 41, as part of operation 204, microcontroller 41 may periodically monitor the operation of the ports 74A . . . 74N to determine whether one or more of the ports 74A . . . 74N has failed and/or has been inactive for the predetermined time period indicated, at least in part, by the one or more parameters 70.

For example, as part of operation 204, microcontroller 41 may periodically poll the ports 74A . . . 74N to provide a predetermined response to the microcontroller 41 in response to the poll. If one or more of the ports 74A . . . 74N fail to provide microcontroller 41 the predetermined response to the polls, the microcontroller 41 may determine that the one or more ports that failed to provide the predetermined response have failed.

Additionally or alternatively, for example, as part of operation 204, microcontroller 41 may monitor the transmission and/or receiving activities of one or more ports 74A . . . . 74N to determine whether one or more of the ports 74A . . . 74N have received and/or transmitted via one or more links 44A one or more packets within the predetermined time period. If one or more of the ports 74A . . . 74N has not received and/or transmitted via one or more links 44A one or more packets within the predetermined time period, microcontroller 41 may determine that the port that has not received and/or transmitted one or more packets via the one or more links within the predetermined time period has been inactive for the predetermined time period.

If microcontroller 41 determines that one or more of the ports (e.g., port 74A) has failed and/or has been inactive for the predetermined time period, microcontroller 41 may signal that port 74A, network interface circuitry 66, interface circuitry 72 and/or circuitry 76. This may result in internal circuitry (not shown) in circuitry 66, interface circuitry 72 and/or circuitry 76 de-coupling port 74A from one or more actuating signals 60. This may result in port 74A entering a powered down state. In this embodiment, even if port 74A is part of a failover team of ports, port 74A may nevertheless be powered down by microcontroller 41 if microcontroller 41 determines that port 74A has been inactive for the predetermined time period.

In this embodiment, if microcontroller 41 determines that one of the ports (e.g., port 74A) has failed, the failed port 74A and another of the ports (e.g., port 74N) are in a failover team, and the other port 74N is currently powered down, microcontroller 41 may signal port 74N, network interface circuitry 66, interface circuitry 72 and/or circuitry 76. This may result in port 74N being coupled to one or more actuating signals 60 and entering a powered up state. After entering the powered up state, port 74N may assume the tasks previously performed by the failed port 74A.

Additionally or alternatively, if an entity (e.g., one or more operating system processes 52) in host 110 desires to access and/or utilize memory 54, memory 56, and/or memory 58, and/or to transmit and/or receive one or more packets via interface circuitry 66, 72, and/or 76, and/or one or more of the ports 74A . . . 74N, the entity may request same by issuing a request to microcontroller 41 to set one or more semaphores comprised in semaphores 80 that are associated with memory 54, memory 56, memory 58, interface circuitry 66, 72, and/or 76, and/or one or more of the ports 74A . . . 74N, respectively. That is, in this embodiment, memory 54, memory 56, memory 58, interface circuitry 66, 72, and/or 76, and/or one or more of the ports 74A . . . 74N may be associated with one or more respective semaphores comprised in semaphores 80. Depending upon whether one or more respective semaphores in semaphores 80 are set or unset, this may indicate whether memory 54, memory 56, memory 58, interface circuitry 66, 72, and/or 76, and/or one or more of the ports 74A . . . 74N, respectively, are currently being used and/or accessed, or not being used and/or accessed, respectively, by an entity in host 110. After receiving such a request, if memory 54, memory 56, memory 58, interface circuitry 66, 72, and/or 76, and/or one or more of the ports 74A . . . 74N are currently powered down, microcontroller 41 may signal memory 54, memory 56, memory 58, interface circuitry 66, 72, and/or 76, and/or one or more of the ports 74A . . . 74N. This may result in memory 54, memory 56, memory 58, interface circuitry 66, 72, and/or 76, and/or one or more of the ports 74A . . . 74N being powered up. Microcontroller 41 may signal the entity that issued the request, and also may set in one or more of the semaphores associated with memory 54, memory 56, memory 58, interface circuitry 66, 72, and/or 76, and/or one or more of the ports 74A . . . 74N. This may indicate to the entity that issued the request that its request has been granted. After the entity has completed its requested access and/or use, the entity may signal microcontroller 41. Microcontroller 41 may unset the one or more semaphores associated with the memory 54, memory 56, memory 58, interface circuitry 66, 72, and/or 76, and/or one or more of the ports 74A . . . . 74N.

Also additionally or alternatively, microcontroller 41 may periodically monitor which of the semaphores 80 are set or unset to determine which of the resources in host 110 that are associated with such semaphores have not been utilized and/or accessed by an entity in host 110 for the predetermined time period. If one or more semaphores associated with a respective resource have not be set for the predetermined time period, microcontroller 41 may determine, as part of operation 204, that the respective resource has been inactive for the predetermined time period, and may determine not to supply to the resource one or more actuating signals 60.

In this embodiment, the operations described herein as being executed by microcontroller 41 result from the execution by microcontroller 41 of one or more processes 84. Microcontroller 41 executes these operations independent of the operating system 50 and/or the operating system instructions executed by processor 12. For example, in order to carry out these operations, microcontroller 41 does not execute any part of operating system 50 and/or the operating system instructions executed by processor 12. As a result, for example, microcontroller 41 may be capable of executing operations 202 and 204 independent of operating system 50, one or more processes 52, and/or the operating system instructions executed by processor 12.

Thus, a system embodiment may comprise a circuit board that comprises a circuit card slot. The system also may comprise a circuit card that is capable of being inserted into the circuit card slot. The circuit card may comprise circuitry that is capable of determining, based at least in part upon one or more parameters, and independently of an operating system, whether to supply to other circuitry one or more actuating signals. The one or more parameters may be issued from an authority that is remote from the circuitry. The one or more parameters may indicate, at least in part, one or more conditions under which the other circuitry is to be powered up or deactivated.

Advantageously, in this system embodiment, the determination of whether to power down the other circuitry may be made independently of the operating system. Advantageously, if the system embodiment is owned by a corporation and possessed by an employee of the corporation, this makes it more difficult for, and/or less likely that an employee will be able to circumvent and/or thwart the corporation's energy conservation policy concerning the system, than is the case in the aforesaid conventional system. Also advantageously, in this system embodiment, other and/or additional power saving features and/or techniques may be carried out, and/or the power use of other and/or additional circuitry may be controlled, in accordance with the one or more parameters issued from the remote authority, than are the case in the aforesaid conventional system.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Additional modifications are also possible. Accordingly, the claims are intended to cover all such equivalents.

What is claimed is:

1. A method comprising:
determining whether to supply to circuitry one or more actuating signals, the determining being based, at least in part, upon one or more parameters issued from an authority that is remote from the circuitry, the one or more parameters indicating, at least in part, one or more conditions under which the circuitry is to be powered up or deactivated.

2. The method of claim 1, wherein:
a host comprises the circuitry;
the host is capable of executing an operating system; and
the determining is performed independently of the operating system.

3. The method of claim 1, wherein:
the one or more actuating signals comprise a voltage signal and/or a current signal; and
the circuitry comprises memory interface circuitry and/or network interface circuitry.

4. The method of claim 3, wherein:
the network interface circuitry comprises medium access control circuitry, port circuitry, and/or physical layer circuitry.

5. The method of claim 1, wherein:
the one or more conditions comprise an inactivity time, residence of a program process in memory, and/or a failure condition; and
the determining is also based, at least in part, upon one or more values of one or more semaphores.

6. The method of claim 1, wherein:
the one or more values indicate, at least in part, whether a request to use the circuitry has been issued and/or whether the request has been granted.

7. An apparatus comprising:
circuitry that is capable of determining whether to supply to other circuitry one or more actuating signals, the determining being based, at least in part, upon one or more parameters issued from an authority that is remote from the circuitry, the one or more parameters indicating, at least in part, one or more conditions under which the other circuitry is to be powered up or deactivated.

8. The apparatus of claim 7, wherein:
a host comprises the other circuitry;
the host is capable of executing an operating system; and
the determining is performed independently of the operating system.

9. The apparatus of claim 7, wherein:
the one or more actuating signals comprise a voltage signal and/or a current signal; and
the other circuitry comprises memory interface circuitry and/or network interface circuitry.

10. The apparatus of claim 9, wherein:
the network interface circuitry comprises medium access control circuitry, port circuitry, and/or physical layer circuitry.

11. The apparatus of claim 7, wherein:
the one or more conditions comprise an inactivity time, residence of a program process in memory, and/or a failure condition; and
the determining is also based, at least in part, upon one or more values of one or more semaphores.

12. The apparatus of claim 7, wherein:
the one or more values indicate, at least in part, whether a request to use the circuitry has been issued and/or whether the request has been granted.

13. One or more storage media storing instructions that when executed by a machine result in operations comprising:
determining whether to supply to circuitry one or more actuating signals, the determining being based, at least in part, upon one or more parameters issued from an authority that is remote from the circuitry, the one or more parameters indicating, at least in part, one or more conditions under which the circuitry is to be powered up or deactivated.

14. The one or more storage media of claim 13, wherein:
a host comprises the circuitry;
the host is capable of executing an operating system; and
the determining is performed independently of the operating system.

15. The one or more storage media of claim 13, wherein:
the one or more actuating signals comprise a voltage signal and/or a current signal; and
the circuitry comprises memory interface circuitry and/or network interface circuitry.

16. The one or more storage media of claim 15, wherein:
the network interface circuitry comprises medium access control circuitry, port circuitry, and/or physical layer circuitry.

17. The one or more storage media of claim 13, wherein:
the one or more conditions comprise an inactivity time, residence of a program process in memory, and/or a failure condition; and
the determining is also based, at least in part, upon one or more values of one or more semaphores.

18. The one or more storage media of claim 13, wherein:
the one or more values indicate, at least in part, whether a request to use the circuitry has been issued and/or whether the request has been granted.

19. A system comprising:
a circuit board comprising a circuit card slot and a circuit card that is capable of being inserted into the circuit card slot, the circuit card comprising circuitry that is capable of:
determining whether to supply to other circuitry one or more actuating signals, the determining being based, at least in part, upon one or more parameters issued from an authority that is remote from the circuitry, the one or more parameters indicating, at least in part, one or more conditions under which the other circuitry is to be powered up or deactivated.

20. The system of claim 19, wherein the circuit board further comprises:
a plurality of host processors; and
a bus coupling the plurality of host processors to the circuit card slot.

21. The system of claim 19, wherein:
a host comprises the circuit board and the circuit card;
a server comprises the authority;
the server is geographically remote from the host; and
the system further comprises a communication network coupling the server to the host.
